(19) United States
(12) Patent Application Publication
(10) Pub. No.: US 2001/0008257 A1
(43) Pub. Date: Jul. 19, 2001

(54) Electrostatic rotary atomizer

(76) Inventors: Thomas Scholz, Rodgau (DE); Udo Klein, Dietzenbach (DE)

Correspondence Address: FASSE PATENT ATTORNEYS, P.A., P.O. BOX 726, HAMPDEN, ME, 04444-0726, US

(21) Appl. No.: 09/765,486

(22) Filed: Jan. 16, 2001

(30) Foreign Application Priority Data
Jan. 15, 2000 (DE) 100 01 570.0

(51) Int. Cl. B05B 5/04; B05B 5/053

(52) U.S. Cl. 239/703; 239/224; 239/264

(57) ABSTRACT

The invention relates to an electrostatic rotary atomizer for coating purposes, with an aerostatic, if appropriate multi-part bearing 3 absorbing axially and radially directed forces and intended for a shaft 4 mounted in suspension in an air gap 21 and carrying an atomizer bell 5.

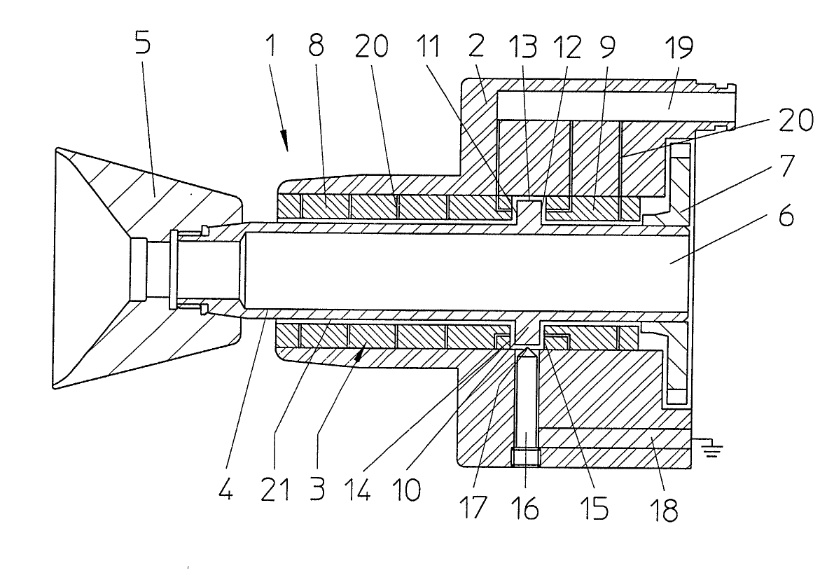

There is provision, as the essence of the invention, for the bearing 3 for the shaft 4 to consist of an electrically non-conductive material.

### DESCRIPTION

The invention relates to an electrostatic rotary atomizer for coating purposes, with an aerostatic, if appropriate multi-part bearing absorbing axially and radially directed forces and intended for a shaft in suspension in an air gap and carrying an atomizer bell, according to the pre-characterizing clause of Patent Claim 1.

The shaft, which is mounted in suspension in the air gap and to the front end of which the atomizer bell is fastened, is charged in the electrostatic field. Although the air gap has only a width of 3 to 30 μm, charge compensation takes place between the suspended shaft and the bearing shell or bearing shells in relation to the atomizer housing which is earthed. Charge compensation is associated with sparking flashing over from the shaft to the bearing shell and gradually leading to the shaft and bearing shells being burnt away. This also results in residues in the bearing region, and the air gap, which widens constantly due to spark erosion, leads to premature bearing wear.

The object on which the invention is based is, therefore, to provide measures for avoiding spark erosion and the shaft being consequently burnt away.

To achieve this object, by means of the features of the characterizing clause of Claim 1, the invention provides for the bearing for the shaft to consist of an electrically non-conductive material.

Charge compensation via the bearing shell between the atomizer bell and the shaft carrying the latter, on the one hand, and the atomizer housing, on the other hand, can no longer take place and also cannot lead to spark erosion, since the shaft and the atomizer housing are separated by the electrically non-conductive layer. The actual bearing surfaces of the aerostatic bearing therefore remain unaffected and the useful life of the bearing is markedly increased.

In a development of the invention, there is provision for at least one electrically conductive electrode to be provided at a defined location on the bearing side. With the aid of this electrode, the electrostatic charge can flow away in a controlled and non-contact manner. This ensures that the atomizer is operable over a long period.

Further features of the invention may be gathered from the description and the subclaims in conjunction with the drawing.

The invention is described in more detail below by means of an exemplary embodiment which is illustrated in the drawing.

An electrostatic rotary atomizer 1 comprises a housing 2 with a bearing 3 for a shaft 4 which carries at one end an atomizer bell 5 and at its other end 6, for example, a turbine wheel 7 serving as a drive. According to the exemplary embodiment, the bearing 3 consists of two hearing shells 8 and 9. The bearing shells 8 and 9 are arranged at a slight distance from one another in the housing 2.

The shaft 4 has a shaft collar 10. With the aid of the shaft collar 10, a bell-side and annular axial supporting surface 11 and an annular and axial supporting surface 12 facing away from the atomizer bell 5 and between these supporting surfaces, radially on the outside, a circumferential surface 13 are provided. The two bearing shells 8 and 9 are in each case arranged on both sides of the shaft collar 10 and in each case form, with these associated end faces, holding or supporting and guiding axial surfaces 14 and 15.

At least one electrically conductive electrode 16 is provided on the bearing side. The electrode 16 has a tip 17 facing the shaft 4. According to the exemplary embodiment, the electrode 16 is arranged in the housing 2 so as to be exchangeable and, if appropriate, adjustable. A conductor 18 is connected to the electrode 16 and serves for earthing.

The bearing 3 or the bearing shells 8 and 9 consist of an electrically non-conductive material, such as, for example, of ceramic and/or plastic.

In the single figure, the shaft 6 is illustrated as a hollow shaft and basically has other components which are not relevant here. It consists, as a rule, of an electrically conductive material, such as steel, but may basically also be manufactured even from an electrically non-conductive material. It then therefore also consists of ceramic and/or plastic.

To form an air cushion in the air gap 21 between the bearing 3 and shaft 4, compressed air is forced into the air gap 21. This is carried out via a compressed-air connection 19. Ducts 20 in the housing 2 and in the bearing shells 8 and 9 of the single figure symbolize the supply of compressed air to the air gap 1.

Finally, the electrode 16 is arranged exchangeably in the housing 2, so that it can easily be replaced, if required.

1. Electrostatic rotary atomizer for coating purposes, with an aerostatic, if appropriate multi-part bearing (3) absorbing axially and radially directed forces and intended for a shaft (4) mounted in suspension in an air gap (21) and carrying an atomizer bell (5), characterized in that the bearing (3) for the shaft (4) consists of an electrically non-conductive material.

2. Rotary atomizer according to claim 1, characterized in that at least one electrically conductive electrode (16) having a non-contact action is assigned to the shaft (4).

3. Rotary atomizer according to at least one of the preceding claims, characterized in that the electrode (16) is arranged exchangeably.

4. Rotary atomizer according to at least one of the preceding claims, characterized in that the electrode (16) has a tip (17) assigned to the shaft (4).

5. Rotary atomizer according to at least one of the preceding claims, characterized in that the bearing (3) comprises at least one bearing shell (8, 9) consisting of ceramic.

6. Atomizer according to at least one of the preceding claims, characterized in that the bearing (3) comprises at least one bearing shell (8, 9) consisting of plastic.

7. Atomizer according to at least one of the preceding claims, characterized in that the shaft (4) has annular and axially directed supporting surfaces (11, 12) which are assigned annular axial surfaces (14, 15) on the bearing side.

8. Rotary atomizer according to at least one of the preceding claims, characterized in that the axially directed supporting surfaces (11, 12) of the shaft (4) limit, together with a circumferential surface (13), a shaft collar (10), and in that the electrode (16) is assigned on the bearing side to the circumferential surface (13) of the shaft collar (10).

9. Rotary atomizer according to at least one of the preceding claims, characterized in that bearing shells (8, 9) are arranged on both sides of the shaft collar (10).

10. Rotary atomizer according to at least one of the preceding claims, characterized in that the shaft collar (10) is arranged on the shaft (4) near that end (6) of the latter which faces away from the atomizer bell (5).

11. Atomizer according to at least one of the preceding claims, characterized in that the shaft (4) at the same time also consists at least partially of an electrically non-conductive material.
